(19) United States
(12) Patent Application Publication
(10) Pub. No.: US 2024/0227687 A1
(43) Pub. Date: Jul. 11, 2024

(54) UNIVERSAL TOPPER FOR EXTERNAL COMPARTMENTS OF VEHICLES AND FOLDING SUPPORT AND TENT ABOVE TOPPER

(71) Applicant: OVERLAND NORTH OUTDOORS, Ft. Meyers, FL (US)

(72) Inventor: Tod A. Bruestle, Ft. Meyers, FL (US)

(21) Appl. No.: 18/532,251

(22) Filed: Dec. 7, 2023

Related U.S. Application Data
(60) Provisional application No. 63/437,560, filed on Jan. 6, 2023.

(51) Int. Cl. B60R 9/058; B60P 3/32

(52) U.S. Cl. CPC B60R 9/058; B60P 3/32

(57) ABSTRACT

An adjustable vehicle topper is provided. The topper is assembled from components that can be separated and stored in a somewhat flat condition for convenience. The topper has several sectioned assemblies that can each be disassembled, disassembled, stored, assembled, and carried by hand, such that the topper overall can be installed, removed, adjusted, and generally handled without hoisting equipment or several workers being needed for such operations. The topper can be used or include configurable support devices having lowered and raised configurations, and a flexible structure such as a tent supported thereby.

### CROSS-REFERENCE TO RELATED APPLICATION

This application claims the benefit of priority of U.S. provisional patent application No. 63/437,560 titled “A Universal Topper for External Compartments of Vehicles,” filed on Jan. 6, 2023, which is incorporated herein in its entirety by this reference.

### TECHNICAL FIELD

The present invention relates to a containment system for an external cargo hold of a vehicle and, more particularly, to an adjustable vehicle topper to enclose or partially enclose the external cargo compartment or bed of a vehicle.

### BACKGROUND

Various types of vehicles, such as pickup trucks and some classic sportsters, muscle cars, station wagons, etc., come equipped with or may be equipped with an exterior cargo bed. Such cargo beds are typically formed from vertical walls or panels of the vehicle body and define an open cargo hold (e.g., a bed or truck bed). The cargo bed of a vehicle generally allows for convenient storage of equipment, personal items, supplies, etc. within the vehicle's pay load capacity. While open cargo beds are convenient for quick and easy storage and removal of items, the walls defining the open cargo bed may not be tall enough to properly secure larger items. Thus, the operator of the vehicle typically must secure larger items for transport utilizing straps, bungee cords, or the like. Additionally, uncovered cargo holds leave any stored items open to the weather and exposed to contaminants associated with driving (splashing, the rain, bug splatter, etc.).

A vehicles equipped with a cargo hold may also be outfitted with a vehicle specific topper in order to assist in securing items placed in the cargo hold for transport and to provide some protection from the environment. However, such vehicle specific toppers may be unavailable or difficult to locate, especially for sought after years of some classic model vehicles. Further, vehicle specific toppers are generally supplied to the vehicle owner permanently or semi-permanently assembly. Thus, the vehicle owner often requires assistance to install a heavy or large topper to a suitable vehicle. The owner of a vehicle specific topper cannot utilize the topper with a different vehicle including an exterior cargo hold. Furthermore, the vehicle owner or operator cannot adjust the dimensions of a vehicle specific topper for different items requiring transport. Thus, the entire topper may require removal if any portion of the item for transport is taller than the enclosed hold formed by the vehicle specific topper.

In view of the circumstances described above, there is a need for a vehicle topper that allows for an operator to adjust the dimensions of the same.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

According to at least one embodiment, a vehicle topper is configured to adjustably couple to an exterior of a vehicle and at least partially enclose an external compartment. The vehicle topper includes a front assembly, a driver side sidewall assembly, and a passenger side sidewall assembly. The front assembly includes a driver side member and a passenger side member that, at least when assembled, define a window, the driver side member and passenger side member adjustably and releasably connected to one another such that a lateral width of at least one of the window or the front assembly is adjustable. The driver side sidewall assembly includes a forward component and a rearward component that, when assembled, form a driver side barrier extending along a driver side longitudinal length extending aft from the driver side member of the front assembly, the forward component and rearward component of the driver side assembly adjustably coupled to one another such that the driver side longitudinal length is adjustable. The passenger side sidewall assembly includes a forward component and rearward component that, when assembled, form a passenger side barrier extending along a passenger side longitudinal length extending aft from the passenger side member of the front assembly, the forward component and rearward component of the passenger side sidewall assembly adjustably coupled to one another such that the passenger side longitudinal length is adjustable.

Each of the driver side member and a passenger side member of the front assembly may include a wall portion, an upper arm extending from the wall portion, and a lower arm extending from the wall portion spaced from and parallel to the upper arm.

The front assembly may include an upper beam and a lower beam between which the window is defined. The upper beam may include the upper arm of the driver side member and the upper arm of the passenger side member adjustably and releasably connected to one another. The lower beam may include the lower arm of the driver side member and the lower arm of the passenger side member adjustably and releasably connected to one another.

The upper arm and lower arm may extend freely from the wall portion in cantilever fashion.

In at least one example, a laterally extending rearward upper beam spans a space between rearward upper ends of the rearward components of the sidewall assemblies.

The rearward upper beam may include a driver side section extending laterally from the rearward component of the driver side assembly, and a passenger side section extending laterally from the rearward component of the passenger side assembly.

The driver side section and passenger side section may be adjustably and releasably connected to one another.

The forward component of the driver side sidewall assembly may include a longitudinally extending upper strip, a longitudinally extending lower strip, and a wall panel defining a portion of the driver side barrier. The forward component of the passenger side sidewall assembly may include a longitudinally extending upper strip, a longitudinally extending lower strip, and a wall panel defining a portion of the passenger side barrier.

The rearward component of the driver side sidewall assembly may include a wall panel defining a portion of the driver side barrier, and at least one of: a longitudinally extending upper strip adjustably coupled to the upper strip of the forward component of the driver side sidewall assembly; and a longitudinally extending lower strip adjustably coupled to the lower strip of the forward component of the driver side sidewall assembly. The rearward component of the passenger side sidewall assembly may include a wall panel defining a portion of the passenger side barrier, and at least one of: a longitudinally extending upper strip adjustably coupled to the upper strip of the forward component of the passenger side sidewall assembly; and a longitudinally extending lower strip adjustably coupled to the lower strip of the forward component of the passenger side sidewall assembly.

A roof panel may span a lateral space between tops of the driver side sidewall assembly and passenger side sidewall assembly.

A longitudinally extending center line of the roof panel is higher than respective top edges of the driver side sidewall assembly and passenger side sidewall assembly, to promote stability and rain water run off.

A rail assembly may span a lateral space between tops of the driver side sidewall assembly and passenger side sidewall assembly, the rail assembly including: a laterally extending cross beam having a driver side lateral end and an opposite passenger side lateral end; a driver side mounting bracket coupled the driver side lateral end; and a passenger side mounting bracket coupled to the passenger side lateral end.

In some examples, the vehicle topper includes a first configurable support device having at least: two brackets; a major rail having an outward end hingedly coupled to one of the two brackets and an inward portion opposite the outward end; and a minor rail having an outward end hingedly coupled to the other of the two brackets and an inward terminal end opposite the outward end. The inward end of the minor rail is adjustably coupled to the inward end portion of the major rail such that the major rail and the minor rail are each pivotable between a respective lowered position together defining a lowered configuration of the first configurable support device and a respective raised position together defining a raised configuration of the first configurable support device.

In the raised configuration, an end terminus of the inward end portion of the major rail may extend beyond and higher than the inward terminal end of the minor rail.

The vehicle topper may include a second configurable support device having: two brackets; a major rail having an outward end hingedly coupled to one of the two brackets and an inward portion opposite the outward end; and a minor rail having an outward end hingedly coupled to the other of the two brackets and an inward terminal end opposite the outward end. The inward end of the minor rail is adjustably coupled to the inward end portion of the major rail such that the major rail and the minor rail are each pivotable between a respective lowered position together defining a lowered configuration of the second configurable support device and a respective raised position together defining a raised configuration of the second configurable support device. One of the two brackets of the first configurable support device is mounted on the driver side sidewall assembly and the other of the two brackets of the first configurable support device is mounted on the passenger side sidewall assembly. One of the two brackets of the second configurable support device is mounted on the driver side sidewall assembly rearward of the one of the two brackets of the first configurable support device and the other of the two brackets of the second configurable support device is mounted on the passenger side sidewall assembly rearward of the other of the two brackets of the first configurable support device.

The vehicle topper may include a flexible structure having at least a sloped first top panel with a sloped forward edge and a sloped rearward edge parallel to the forward edge. The forward edge of the top panel can be supported by the major rail of the first configurable device in the raised configuration thereof. The rearward edge of the top panel can be supported by the major rail of the second configurable device in the raised configuration thereof.

The flexible structure may include a sloped second top panel supported by the minor rail of the first configurable device and the minor rail of the second configurable device, and a vertical panel closing out a vertical area between the first top panel and second top panel.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions..

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1A is a top perspective view of an embodiment of an adjustable vehicle topper, according to an exemplary embodiment of the present disclosure.

FIG. 1B illustrates a plan view of a typical vehicle having a cargo bed for reference in describing installment and use of the topper of FIG. 1A.

FIG. 2A is an elevation view of the forward end topper of FIG. 1A.

FIG. 2B is an elevation view of the rearward end of the topper of FIG. 1A.

FIG. 2C is a plan view from overhead of the topper of FIG. 1A.

FIG. 2D is a view from beneath the topper of FIG. 1A.

FIG. 2E is a side view of the topper of FIG. 1A, of which an opposing side is not illustrated and would appear as a mirror-image.

FIG. 3 is an exploded perspective view showing the topper of FIG. 1A disassembled to separately illustrate its front assembly and sidewalls, each of which is shown as assembled.

FIG. 4 is a further exploded perspective view the topper as in FIG. 3, here showing the front assembly and sidewalls disassembled to separately illustrate components thereof.

FIG. 5 is a perspective view of the topper of FIG. 1A with an attached top rack assembly according to at least one embodiment.

FIG. 6 is a side elevation view of the topper and top rack assembly of FIG. 5.

FIG. 7 is front elevation view of the topper and top rack assembly of FIG. 5.

FIG. 8 is a perspective view of a mounting bracket by which the top rack assembly in

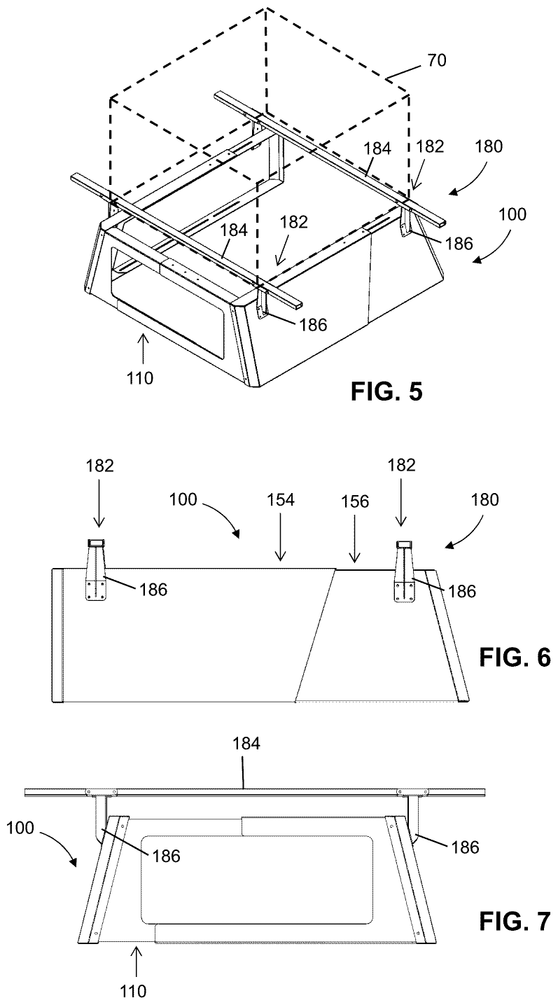

FIGS. 5-7 is attached to the topper.

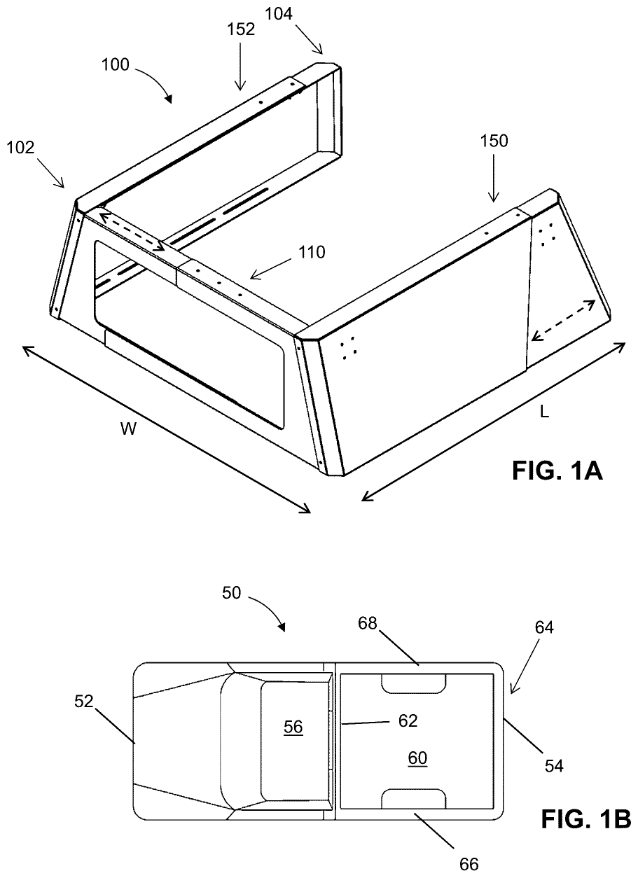

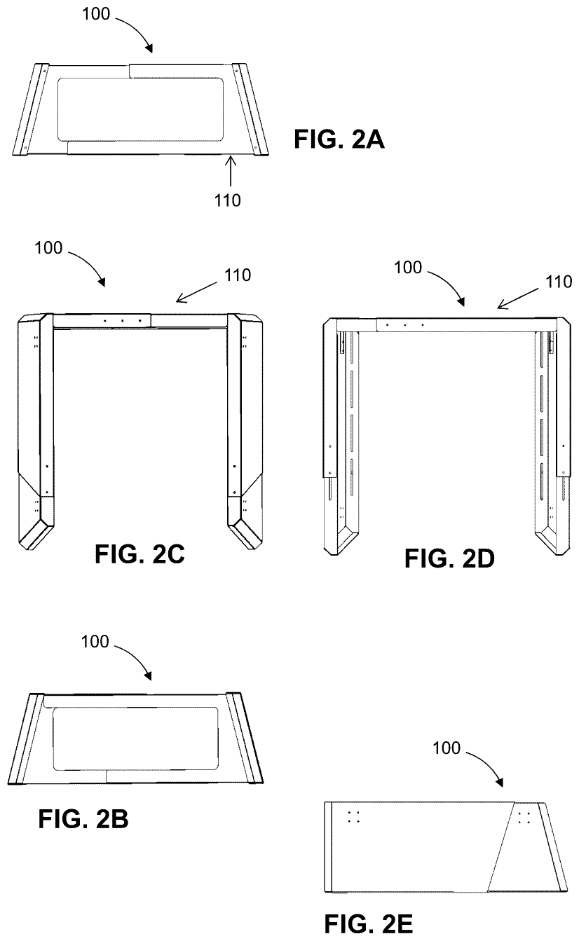

FIG. 9 is a perspective view of the vehicle topper as in FIG. 1, shown with a flexible cover according to at least one embodiment.

FIG. 10 is a perspective view of the topper with a laterally extending upper beam spanning the rearward ends of the sidewalls for strengthening.

FIG. 11 shows a configurable support device, according to at least one embodiment, in a linear lowered configuration.

FIG. 12 shows the configurable support device of FIG. 11, in an angled raised configuration.

FIG. 13 is a perspective view of two support devices, raised as in FIG. 12, mounted to respective forward and rearward upper ends of the sidewalls of the topper of FIG. 10 which is mounted over the cargo bed of a vehicle.

FIG. 14 is a perspective view of a flexible structure, such as a tent in at least one embodiment, supported by the support devices raised as in FIG. 13.

FIG. 15 is a perspective view of the flexible structure supported as in FIG. 14, with foreground portions of the structure shown transparent for illustration of the interior of the structure.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a,” “an,” and “the” refer to “one or more” when used in the subject specification, including the claims. Unless indicated to the contrary, the numerical parameters set forth in the instant specification and attached claims are approximations that can vary depending upon the desired properties sought to be obtained within the scope of these descriptions.

An adjustable vehicle topper 100 is shown in the drawings according to at least one embodiment. The topper is assembled from components that can be separated and stored in a somewhat flat condition for convenience. The topper has several sectioned assemblies that can each be disassembled, stored, assembled, and carried by hand, such that the topper overall can be installed, removed, adjusted, and generally handled without hoisting equipment or several workers being needed for such operations.

For convenience and reference, a typical vehicle 50, shown as a truck, with a cargo bed is shown in FIG. 1B. The vehicle is shown for reference in describing the topper of FIG. 1A and other drawings, especially with regard to terms such as forward and fore, and rearward and aft, referring to intuitive longitudinal directional senses and an expected installment of the topper on a vehicle. Such conventions do not limit embodiments of the topper to particular use with, nor particular installation on, the illustrated vehicle. The vehicle 50 has a longitudinal forward end 52 and an opposite rearward end 54. A forward engine compartment and occupant cab 56 defining a forward section of the vehicle. The vehicle 50 has a cargo bed 60 generally rearward of the forward section. The cargo bed 60 is generally aft of the cab 56, which may or may not have a rearward facing window. A typical cargo bed 60 has a laterally extending forward wall 62, a rear tailgate area 64 with or without tailgate, and longitudinally extending lateral sidewalls 66 and 68.

The topper 100 is useful at least for installment on the vehicle 50, increasing the function of the cargo bed 60 as an external compartment, enclosure or at least partial enclosure, thereby securing loads to protect carried property and reduce, for example, the loss of hauled material to wind and other destabilization. In keeping with nominal conventions above as used for description of the vehicle 50, the topper 100 has a longitudinal forward end 102 and an opposite rearward end 104. By advantageous features as described the following, the topper 100 is dimensionally adjustable (see dashed arrows) along its lateral width W, defined by adjustment of a laterally-extending front assembly 110, and along its longitudinal length L, as defined by adjustment of two longitudinally extending sidewall assemblies 150 and 152, each of which extends rearward from a respective lateral end of the front assembly 110 and serve as a side barrier. Thus the topper 100 is configurable and adjustable to be installed onto a variety of vehicles 50, each according to their particular dimensions.

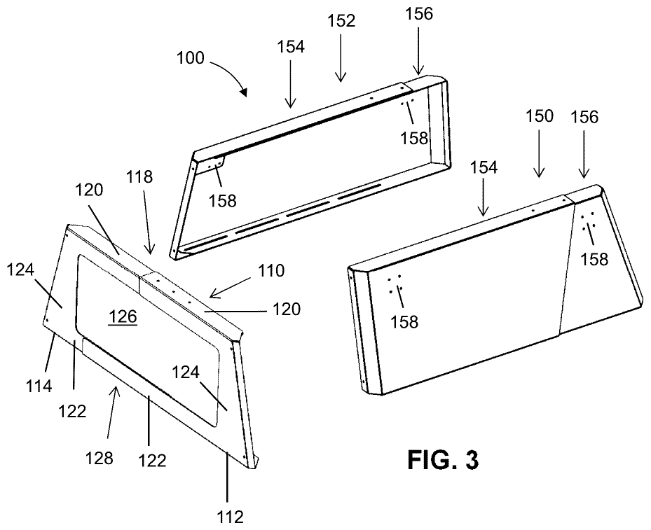

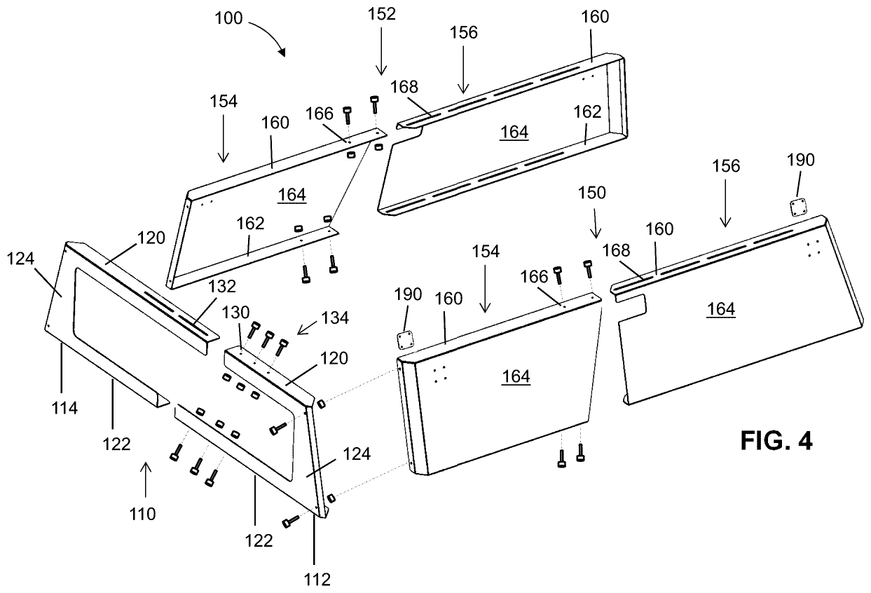

The front assembly 110 includes a first member 112 (FIGS. 3-4) and a second member 114 that are separable, and slidably adjustable relative to each other, and engage to effectively fix the width of the topper assembled. Each of the first member has a laterally extending upper arm 120, a laterally extending lower arm 122 vertically spaced from the upper arm, and a front wall portion 124 to which the upper arm 120 and lower arm 122 are connected and from which they extend parallel freely each in cantilever fashion when disassembled. The upper and lower arms (120, 122) of the first member 112 respectively extend toward and engage the upper and lower arms (120,122) of the second member 114. As referenced in the drawings, the first member 112 may be considered the driver side member, and the second member 114 may be considered the passenger side member, with reference for example to driving laws in the United States where automobiles drive along the right side of roadways wherever two-way traffic is encountered. These descriptions encompass other legal driving conventions and as such driver side and passenger side are relative and nominal terms.

As the arms engage as shown in FIG. 3, they define an upper beam 118, a lower beam 128, and a window 126 due to the vertical spacing therebetween such that the forward wall of the topper effectively defined by the front assembly 110 has an open window aperture for driving convenience as a driver for example uses a rearview mirror within the cab or otherwise looks rearward into or across the cargo bed.

Thus, the upper beam 118 has two sections, each a respective part (120) of the first member 112 and second member 114. Similarly, the lower beam 128 has two sections, each a respective part (122) of the first member 112 and second member 114. Each arm (120,122) is formed as an L-channel in the illustrated embodiment. Cooperating hole 130 and slot 132 patterns as illustrated (FIG. 4) or otherwise in other examples, among the engaging arms (120, 122) of the first member 112 and second member 114 permit sliding adjustment of the overlapping L-channels (arms) and fixing by connectors 134 illustrated as bolt and nut sets. Other connectors and adjustable fixing arrangements and modes are within the scope of these descriptions with respect to various embodiments of the topper 100.

Furthermore, in the illustrated embodiments, each of the first member 112 and second member 114 is constructed from a single piece of flat metal stock, such a aluminum or steel. The L-channels and stiffening side flaps along outer margins of the wall portions 124 are formed by bending along predetermined lines. The longitudinally extending lateral sidewall assemblies 150 and 152 are similarly formed in the illustrated embodiment, each from a single piece of flat metal stock, such as aluminum or steel, and shaped by bending along predetermined lines. In keeping with the above-described convention, the first sidewall assembly 150 may be considered the driver side sidewall assembly or barrier, and the second sidewall assembly 152 may be considered the passenger side sidewall assembly or barrier.

The longitudinally extending lateral sidewall assemblies 150 and 152 are symmetric, being mirror images of each other across a center plane of the topper, and as such, a single description is sufficient. Each sidewall (150, 152) has a forward component 154 and rearward component 156 (FIG. 3, 4) that are separable (FIG. 4), and slidably adjustable relative to each other, and engage to effectively fix the length of the topper assembled. Each of the forward component 154 and the rearward component 156 has a longitudinally extending upper strip 160 (FIG. 4), a longitudinally extending lower strip 162, and a wall panel 164 connecting the upper strip and lower strip. The upper and lower strips of the forward component 154 respectively engage the upper and lower strips of the rearward component 156, with cooperating hole 166 and slot 168 patterns as illustrated (FIG. 4) or otherwise in other examples to permit sliding adjustment of overlapping portions and fixing by connectors illustrated as bolt and nut sets. Other connectors and adjustable fixing arrangements and modes are within the scope of these descriptions with respect to various embodiments of the topper.

When assembled as the illustrated topper 100, the forward cupped edge of the forward component 154 of each lateral sidewall assembly 150 and 152 overlaps and engages a respective outer margin of the wall portion 124 of the corresponding respective member (112,114) of the front assembly 110. In the illustrated embodiment, aligned holes are formed prior to attaching of the sidewalls to the front assembly for use of bolts and nuts to secure the connection.

The topper 100 can thus be adjustably assembled and attached to the cargo bed of a vehicle, such as the vehicle 50 illustrated as a truck as a non-limiting example in FIG. 1B. For example, clamps can be used to secure the lower strips 162 to the tops of the sidewalls 66 and 68 of the cargo bed 60. The lower strips 162 when so installed serve together as a support base for the topper 100.

The topper 100 of FIG. 1A can be used with an attached top rack assembly 180 as shown in FIG. 5 according to at least one embodiment. The top rack 180 can be used to increase the carrying capacity of vehicle and topper, for example to support a roof storage pod 70, or other structure or equipment such as ladders, stock materials, construction materials, tools, etc.

The top rack assembly includes two rail assemblies 182, each spanning the lateral space between the sidewall assemblies 150 and 152. Each rail assembly 182 includes a laterally extending cross beam 184 having opposing lateral end portions, each of which is coupled to and supported by a respective mounting bracket 186 attached to a sidewall of the topper 100. The mounting brackets 186 of the forward rail assembly 182 are attached to the forward components 154 of the sidewall assemblies 150 and 152, and the rearward mounting brackets 186 are attached to rearward components 156, each at mounting positions 158 (FIG. 3) where hole patterns are formed to accommodate connectors. To facilitate mounting, each bracket includes a fixed lower plate 188 having a hole pattern matching that of the mounting positions 158.

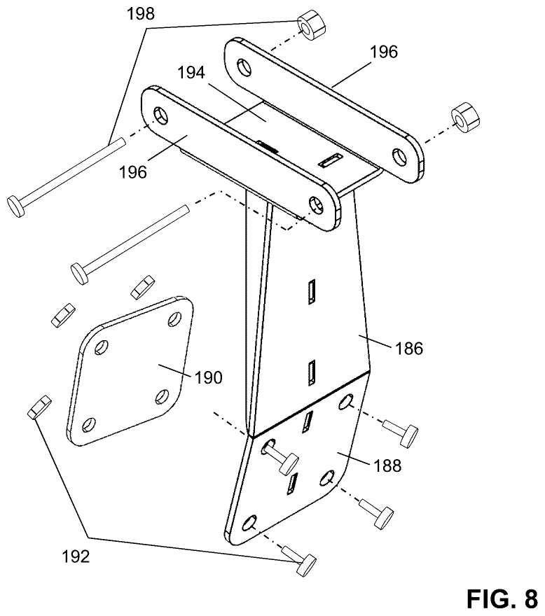

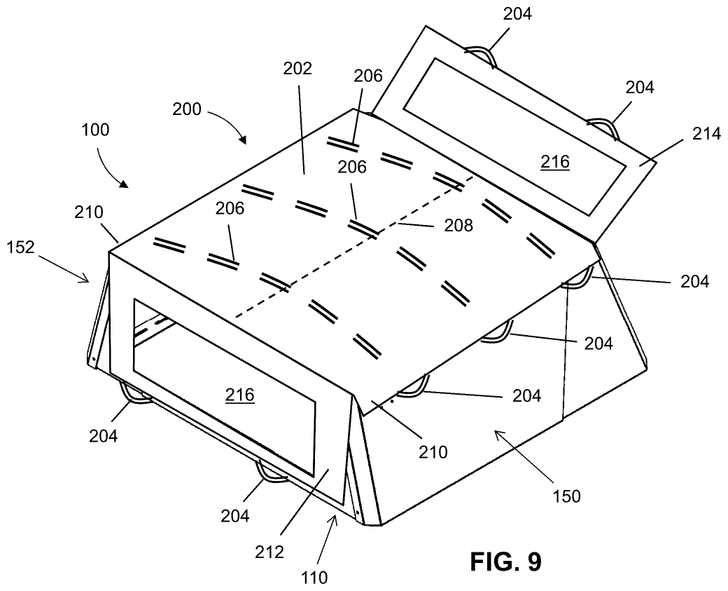

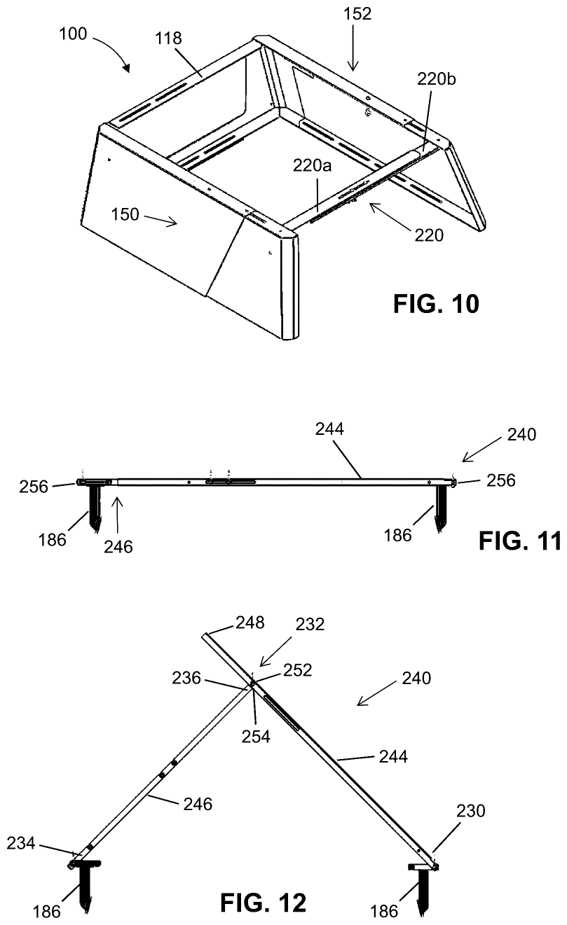

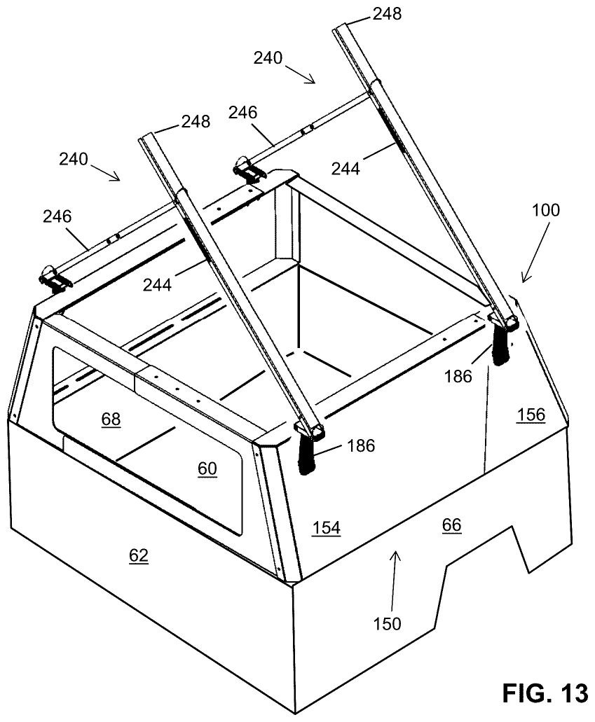

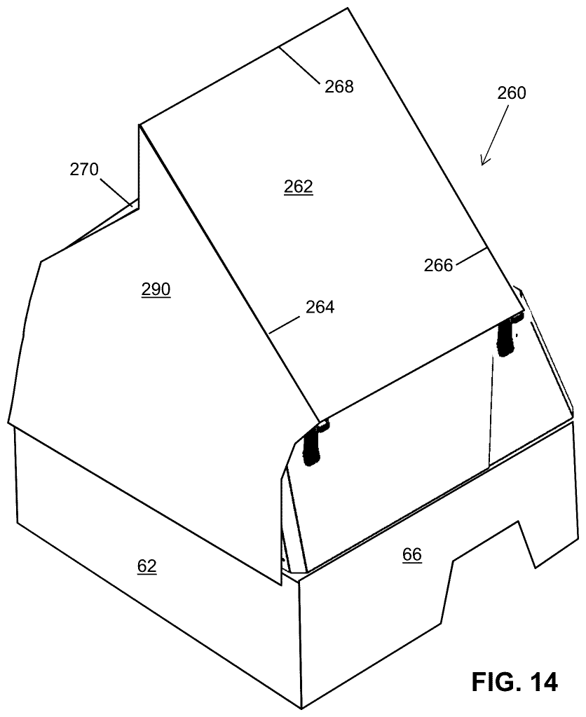

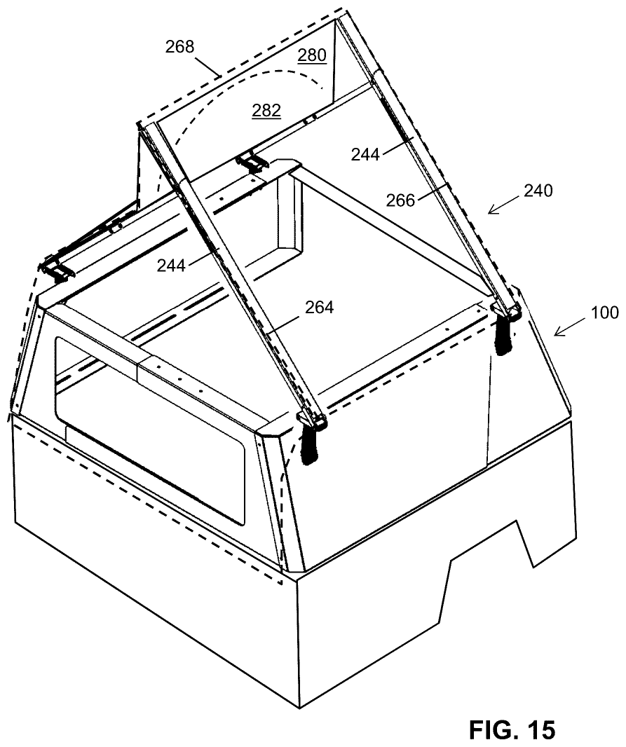

Accompanying each bracket, to increase material engagement and strength upon mounting, a topper interior-side backing plate 190 aligns with the corresponding topper exterior-side lower plate 188 (FIG. 8). The backing plate 190 has a hole pattern matching that of the mounting positions 158 and lower plate 188. When installed on the topper 100, the lower plate 188 and backing plate 190 sandwich a material portion of the corresponding sidewall component 154 or 156 at a mounting position 158 (FIG. 3), with connectors shown as bolt and nut sets 192 in FIG. 8 securing the attachment.

To facilitate connection to and support of a cross beam 184 (FIG. 5), each mounting bracket 186 includes a fixed mount illustrated as a horizontal plate 194 with an attached pair of upward and laterally extending top rails 196, each having holes for use in connecting the bracket to an overhead rail assembly 182, for example by bolt and nut sets 198 as illustrated as a non-limiting example.

A flexible cover 200, according to at least one embodiment, is shown in FIG. 9 mounted on the vehicle topper 100. The flexible cover 200 includes a central roof panel 202 that spans the otherwise open top of the vehicle topper 100, extending laterally between the sidewall assemblies 150 and 152, and extending longitudinally from the front assembly 110 to the upper rearward ends of the sidewall assemblies 150 and 152. The roof panel 202 is illustrated as generally rectangular. The cover 200 can be secured to the topper 100 by use of, for example, loops 204 engaging hooks, tethers, or other features of the topper or vehicle. Loops 204 are shown for example spaced along and attached to lateral edges of the roof panel 202. The loops can be fabricated from, as non-limiting examples, shock cord, synthetic cord, belt, rope, cable, or other tension supporting line or material. The roof panel 200 is thus held taut to serve as a top barrier to protect loads from rain, wind, sun, and loss.

In the illustrated embodiment, the roof panel 202 is further supported by arched members 206, shown in dashed line, spanning the lateral space between the tops of the sidewall assemblies 150 and 152. The arched members 206 raise a longitudinally extending center line of the roof panel 202, higher than top edges of the sidewall assemblies 150 and 152, to promote stability and rain water run off. The arched members 206 can be flexible and resilient, applying a spring like force upward on the roof panel 202 from below. In some embodiments, the roof panel 202 includes sleeves to receive the arched members 206. The arched members can be fabricated from flexible or rigid materials, including as non-limiting examples, PVC tubing or PVC structure, other plastics, flexible poles, sectioned poles or rods, fiberglass, aluminum, steel, and other metals.

The arched members 206 may be each have a two-piece, or other number, telescoping construction to accommodate various vehicle widths to which the topper 100 can be adjusted as already described. In examples in which the arched members are flexible, some degree of varying width accommodation is provided by their flexible arching shape by which the height of the center line 208 of the roof panel 202 can vary with corresponding variations in width. To provide top barrier coverage and accommodate various vehicle widths to which the topper 100 can be adjusted, and to promote for examples rain water run off, the illustrated roof panel 202 extends laterally over top edges of the sidewall assemblies 150 and 152, having respective side portions 210 that further overlap the sidewall assemblies in lesser width adjustments of the topper 100.

The illustrated cover 200 includes a forward flap 212 and a rearward flap 214 extending respectively forward and aft of the roof panel 202 to provide further coverage of the topper 100 and corresponding protection from the elements. Loops 204 as already described, are spaced along and attached to edges of the forward flap 212 and a rearward flap 214 to facilitate their closure and/or taut condition. The forward flap 212 and rearward flap 214 are each illustrated as having a respective window portion 216, which represents, in non-limiting examples, clear portions, translucent portions, open portions, vented portions, screened portions, and portions having zippered boundaries for opening and scaling according to tentative preference in use. The rearward flap 214, for example, can be rolled upward toward its margin with the roof panel 202, and held in a gathered condition by belts, straps, or strings. Similarly, the forward flap 212 can be rolled upward toward its margin with the roof panel 202 and similarly held.

The roof panel 202 and the forward flap 212 and rearward flap 214 are fabricated, in whole or in part, in non-limiting examples, fabric, synthetic fabric such as nylon fabric, plasticized fabric, tarp material, cotton or other natural fiber fabric, fabric that is oiled or otherwise weather conditioned, sheet plastic, and leather.

FIG. 10 shows the topper 100 with an attached laterally extending rearward upper beam 220 spanning the lateral space between the rearward upper end of the rearward components 156 of the sidewalls (150,152). The rearward upper beam 220 is opposite the laterally extending forward upper beam 120 across the longitudinal space of the topper along the tops of the sidewalls (150,152). The rearward upper beam 220 has two sections, a driver side section 220a and a passenger side section +220b, which are adjustably and releasable connected for various width requirements of the topper, similarly to the forward upper beam 120, for example by slots, holes, and connectors as described above with reference to FIG. 4. The beam 220 can be formed as two sections of L-channel with cooperating holes and slots as illustrated. Together the forward upper beam 120 and rearward upper beam 220 strengthen the topper along the upper ends of the sidewalls (150,152).

The topper 100 of FIG. 1A can be used with or include a supported flexible structure, for example shown as a tent in in FIG. 14. For supporting such a structure, a configurable support device 240, according to at least one embodiment, is shown in FIG. 11 in a linear lowered configuration, and in an angled raised configuration in FIG. 12. Like the rail assemblies 182 of FIGS. 5-6, any number of configurable support devices 240 can be mounted on a topper spanning the lateral space between the sidewall assemblies 150 and 152. Each configurable support device 240 includes a configurable rail set, having opposing lateral end portions, each of which is coupled to and supported by a respective mounting bracket 186 attached to a sidewall of the topper 100 as described above with reference to FIG. 8.

Each in its linear lowered or lay flat configuration (FIG. 11), the configurable support devices 240 can serve similarly as a rail assemblies 182 (FIG. 5) to support a roof storage pod 70, or other structure or equipment such as ladders, stock materials, construction materials, tools, etc. The previously described cross beams 184 are illustrated as linear rigid one-piece beams. Each configurable support device 240, alternatively, has a configurable rail set that can be transitioned between the linear lowered configuration of FIG. 11 and the angled raised configuration in FIG. 12.

The rail set as illustrated includes two mutually coupled linear rails, referenced in FIGS. 12-13 as a major first rail 244 and a minor second rail 246. The major first rail 244 has an outward end 230 hingedly coupled to a first bracket 186, and an inward end portion 232 opposite the outward end. The minor second rail 246 has an outward end 234 hingedly coupled to a second bracket 186 opposite the first, and an inward terminal end 236 opposite the outward end. The inward end 236 of the minor second rail 246 is adjustably coupled to the inward end portion 232 of the major first rail 244 permitting the rail set to hinge upward from the linear lowered configuration of FIG. 11 to the angled raised configuration in FIG. 12, where the minor second rail 246 supports and maintains the major first rail 244 in a raised position in cooperation with the respective bracket 186. The configurable support devices 240 is manually adjustable, transitioning between the raised and lowered configurations by user action.

To reach the raised configuration, the major first rail 244 pivots upward around its outward end 230 to a raised position, and the minor second rail 246 pivots upward around its outward end 234 to a raised position. The adjustable coupling may be facilitated by various types of adjustable and releasable connections, including slots, holes, and various fasteners, including for example a removable hinge pin 252 and a T washer 254, as non-limiting examples. The outward ends may have end caps 256 (FIG. 11) for aesthetics and weather resistance.

The major first rail 244 can be formed from three-sided stock, with a downward facing channel to receive a portion of the minor second rail 246 in the linear lowered configuration. The minor second rail 246 can be formed from four-sided stock for strength, having a width accommodated by the channel defined by the first rail 244. In the raised configuration in FIG. 12, an end terminus 248 of the inward end portion 232 of the major first rail 244, opposite the outward end 230, extends beyond and higher than the inward terminal end 236 of the second minor rail 246, overhanging a portion of the second minor rail 246 as shown in FIGS. 12 and 13. This advantageously defines a multi-faceted support architecture for supporting a flexible structure having a skillion top design as shown in FIGS. 14-15.

Two configurable support devices 240 are shown in their raised configurations in FIG. 13 mounted on respective forward and rearward upper ends of the sidewalls of a topper 100 mounted over the cargo bed 60 of a vehicle. A flexible structure 260, useful for example as a tent for camping or other recreational or work site uses, is shown in FIG. 14. The flexible structure 260 includes a sloped first top panel 262 having a sloped forward edge 264 and a parallel sloped rearward edge 266, marked in dashed line in FIG. 15. The forward edge 264 is supported by the raised major first rail 244 at the forward end of the topper 100. The rearward edge 266 (FIGS. 14-15) is supported by the raised major first rail 244 at the rearward end of the topper 100. In the illustrated embodiment, the first top panel 262 hangs over a driver-side portion of the cargo bed of the vehicle.

The flexible structure includes a second top panel 270 supported by the raised minor second rails 244 at forward and rearward ends of the topper. The second top panel 270 covers a passenger-side portion of the cargo bed of the vehicle. A top edge 268 of the first top panel 262 is higher and aligned over a top edge of the second top panel 270, defining a skillion top design. A vertical panel 280 (FIG. 15) closes out a vertical area between the top panels. The vertical panel 280 has respective top and bottom edges connected respectively to the top edge 268 of the first top panel 262 and a corresponding top edge of the lower second top panel 270. In the illustrated embodiment, the vertical panel 280 includes a zippered door panel 282 shaped as a circular segment. The opening defined when the door panel is open may be screened.

A forward panel 290 extends downward from the forward edges of the first and second top panels, for example having respective edges sewn to each and to the vertical panel. A rearward panel, for example of similar shape and construction as the forward panel 290, may extend downward from the rearward edges of the first and second top panels. The rearward panel may include a zippered door for entry to the interior of the flexible structure 260.

The flexible structure 260 can be fabricated, in whole or in part, in non-limiting examples, fabric, synthetic fabric such as nylon fabric, plasticized fabric, tarp material, cotton or other natural fiber fabric, fabric that is oiled or otherwise weather conditioned, sheet plastic, and leather.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A vehicle topper configured to adjustably couple to an exterior of a vehicle and at least partially enclose an external compartment of the vehicle, the vehicle topper comprising:
a front assembly including a driver side member and a passenger side member that, when assembled, define a window, the driver side member and passenger side member configured to slidably couple to one another such that a width of the front assembly is adjustable; and
a driver side sidewall assembly including a forward component and a rearward component that, when assembled, form a driver side barrier extending along a driver side length extending aft from the driver side member of the front assembly, the forward component and rearward component of the driver side assembly slidably coupled to one another such that the driver side length is adjustable,
wherein fastening at least one of the driver side member or the passenger side member of the front assembly to the exterior of the vehicle fixes a width of the window of the front assembly.

2. The vehicle topper of claim 1, wherein fastening at least one of the forward component or the rearward component of the driver side sidewall assembly to the exterior of the vehicle fixes the driver side length of the driver side sidewall assembly.

3. A vehicle topper configured to adjustably couple to an exterior of a vehicle and at least partially enclose an external compartment, the vehicle topper comprising:
a front assembly including a driver side member and a passenger side member configured to be slidably coupled to one another such that a width of the front assembly is adjustable; and
a sidewall assembly including a forward component and a rearward component that, when assembled, form a side barrier extending along a side length extending aft from the front assembly, the forward component and the rearward component of the sidewall assembly slidably coupled to one another such that the side length is adjustable,
wherein fastening at least one of the driver side member or the passenger side member of the front assembly to the exterior of the vehicle fixes the width of the front assembly, and
wherein fastening at least one of the forward component or rearward component of the side assembly to the exterior of the vehicle fixes the side length of the sidewall assembly.

4. A vehicle topper configured to adjustably couple to an exterior of a vehicle and at least partially enclose an external compartment, the vehicle topper comprising:
a front assembly including a driver side member and a passenger side member that, at least when assembled, define a window, the driver side member and passenger side member adjustably and releasably connected to one another such that a lateral width of at least one of the window or the front assembly is adjustable;
a driver side sidewall assembly including a forward component and a rearward component that, when assembled, form a driver side barrier extending along a driver side longitudinal length extending aft from the driver side member of the front assembly, the forward component and rearward component of the driver side assembly adjustably coupled to one another such that the driver side longitudinal length is adjustable; and
a passenger side sidewall assembly including a forward component and rearward component that, when assembled, form a passenger side barrier extending along a passenger side longitudinal length extending aft from the passenger side member of the front assembly, the forward component and rearward component of the passenger side sidewall assembly adjustably coupled to one another such that the passenger side longitudinal length is adjustable.

5. The vehicle topper of claim 4, wherein each of the driver side member and a passenger side member of the front assembly comprises a wall portion, an upper arm extending from the wall portion, and a lower arm extending from the wall portion spaced from and parallel to the upper arm.

6. The vehicle topper of claim 5, wherein:
the front assembly comprises an upper beam and a lower beam between which the window is defined;
the upper beam comprises the upper arm of the driver side member and the upper arm of the passenger side member adjustably and releasably connected to one another; and
the lower beam comprises the lower arm of the driver side member and the lower arm of the passenger side member adjustably and releasably connected to one another.

7. The vehicle topper of claim 5, wherein, when disassembled, the upper arm and lower arm extend freely from the wall portion in cantilever fashion.

8. The vehicle topper of claim 4, further comprising a laterally extending rearward upper beam spanning a space between rearward upper ends of the rearward components of the sidewall assemblies.

9. The vehicle topper of claim 8, wherein the rearward upper beam comprises:
a driver side section extending laterally from the rearward component of the driver side assembly; and
a passenger side section extending laterally from the rearward component of the passenger side assembly;

10. The vehicle topper of claim 9, wherein the driver side section and passenger side section are adjustably and releasably connected to one another.

11. The vehicle topper of claim 4, wherein:
the forward component of the driver side sidewall assembly comprises a longitudinally extending upper strip, a longitudinally extending lower strip, and a wall panel defining a portion of the driver side barrier; and
the forward component of the passenger side sidewall assembly comprises a longitudinally extending upper strip, a longitudinally extending lower strip, and a wall panel defining a portion of the passenger side barrier.

12. The vehicle topper of claim 11, wherein:
the rearward component of the driver side sidewall assembly comprises:
a wall panel defining a portion of the driver side barrier; and
at least one of:
a longitudinally extending upper strip adjustably coupled to the upper strip of the forward component of the driver side sidewall assembly; and
a longitudinally extending lower strip adjustably coupled to the lower strip of the forward component of the driver side sidewall assembly, and
the rearward component of the passenger side sidewall assembly comprises:
a wall panel defining a portion of the passenger side barrier; and
at least one of:
a longitudinally extending upper strip adjustably coupled to the upper strip of the forward component of the passenger side sidewall assembly; and
a longitudinally extending lower strip adjustably coupled to the lower strip of the forward component of the passenger side sidewall assembly.

13. The vehicle topper of claim 4, further comprising a roof panel spanning a lateral space between tops of the driver side sidewall assembly and passenger side sidewall assembly.

14. The vehicle topper of claim 13, a longitudinally extending center line of the roof panel is higher than respective top edges of the driver side sidewall assembly and passenger side sidewall assembly, to promote stability and rain water run off.

15. The vehicle topper of claim 4, further comprising a rail assembly spanning a lateral space between tops of the driver side sidewall assembly and passenger side sidewall assembly, the rail assembly comprising:
a laterally extending cross beam having a driver side lateral end and an opposite passenger side lateral end;
a driver side mounting bracket coupled the driver side lateral end; and
a passenger side mounting bracket coupled to the passenger side lateral end.

16. The vehicle topper of claim 4, further comprising a first configurable support device comprising:
two brackets;
a major rail having an outward end hingedly coupled to one of the two brackets and an inward portion opposite the outward end; and
a minor rail having an outward end hingedly coupled to the other of the two brackets and an inward terminal end opposite the outward end,
wherein the inward end of the minor rail is adjustably coupled to the inward end portion of the major rail such that the major rail and the minor rail are each pivotable between a respective lowered position together defining a lowered configuration of the first configurable support device and a respective raised position together defining a raised configuration of the first configurable support device.

17. The vehicle topper of claim 16, wherein, in the raised configuration, an end terminus of the inward end portion of the major rail extends beyond and higher than the inward terminal end of the minor rail.

18. The vehicle topper of claim 16, further comprising a second configurable support device comprising:
two brackets;
a major rail having an outward end hingedly coupled to one of the two brackets and an inward portion opposite the outward end; and
a minor rail having an outward end hingedly coupled to the other of the two brackets and an inward terminal end opposite the outward end,
wherein the inward end of the minor rail is adjustably coupled to the inward end portion of the major rail such that the major rail and the minor rail are each pivotable between a respective lowered position together defining a lowered configuration of the second configurable support device and a respective raised position together defining a raised configuration of the second configurable support device,
wherein:
one of the two brackets of the first configurable support device is mounted on the driver side sidewall assembly and the other of the two brackets of the first configurable support device is mounted on the passenger side sidewall assembly; and
one of the two brackets of the second configurable support device is mounted on the driver side sidewall assembly rearward of the one of the two brackets of the first configurable support device and the other of the two brackets of the second configurable support device is mounted on the passenger side sidewall assembly rearward of the other of the two brackets of the first configurable support device.

19. The vehicle topper of claim 18, further comprising a flexible structure comprising a sloped first top panel having a sloped forward edge and a sloped rearward edge parallel to the forward edge, wherein:
the forward edge of the top panel is supported by the major rail of the first configurable device in the raised configuration thereof; and
the rearward edge of the top panel is supported by the major rail of the second configurable device in the raised configuration thereof.

20. The vehicle topper of claim 19, wherein the flexible structure further comprises:
a sloped second top panel supported by the minor rail of the first configurable device and the minor rail of the second configurable device; and
a vertical panel closing out a vertical area between the first top panel and second top panel.
